(19) United States
(12) Patent Application Publication
(10) Pub. No.: US 2018/0289011 A1
(43) Pub. Date: Oct. 11, 2018

(54) METHOD OF PREPARING AN ANTIMICROBIAL COMPOSITION

(71) Applicants: Dow Global Technologies LLC, Midland, MI (US); Rohm and Haas Company, Collegeville, PA (US)

(72) Inventors: Nicholas P. Mitchell, West Cheater, PA (US); Brandon Russell, Alburtis, PA (US); Kevin B. Vargo, Collegeville, PA (US)

(21) Appl. No.: 15/756,695

(22) PCT Filed: Sep. 26, 2016
(86) PCT No.: PCT/US16/53692

§ 371 Date: Mar. 1, 2018

Related U.S. Application Data
(60) Provisional application No. 62/234,858, filed on Sep. 30, 2015.

(51) Int. Cl. A01N 59/20; A01N 59/16

(52) U.S. Cl. CPC A01N 59/20; A01N 59/16

(57) ABSTRACT

The present invention relates to a method for preparing a stable antibacterial composition.

The present invention relates to a method of preparing an antimicrobial composition.

The constant threat of microbial contamination and the associated repercussions on health and wellness as well as adverse effects microbes can cause to the aesthetics and durability of products have made antimicrobial solutions a ubiquitous component of consumer and institutional products. Many materials such as textiles, paints and coatings and building materials can support the growth of microbes and are often protected with antimicrobials. Some antimicrobials such as triclosan are no longer acceptable in many of these applications due to concerns around human and environmental safety. Some antimicrobials are acceptable, but are difficult to apply into or onto materials. Inorganic metal ions such as silver, copper and zinc can provide antimicrobial benefits to materials. However, many metal ion antimicrobials are supplied as inorganic particulates which are difficult to incorporate. Liquid, non-particulate formulations of metal antimicrobials are easier to incorporate, but these formulations often have poor stability and a short shelf life. There is therefore a need for the development of new stable liquid, non-particulate formulations of metal ions which are easy to incorporate into or apply onto materials and that can provide sustained antimicrobial efficacy.

U.S. Pat. No. 7,390,774 discloses one such formulation. The cited reference describes an antimicrobial composition comprising a metal complexed with a polymer, wherein the metal is selected from copper, silver, gold, tin, zinc and combinations thereof. It has been discovered that while such compositions are efficacious, the formulations themselves do not have acceptable stability over extended periods of time. Thus there exists a need in the art to increase the stability of these metal/polymer antimicrobial compositions.

The present invention solves the problem in the art by providing a method for preparing a stable formulation comprising:

i) providing a solution of:
a) a salt of a metal;
b) a nitrogen containing base; and
c) water

ii) mixing the solution with a polymer wherein the polymer contains metal ion ligands.

As used herein “stable” means producing a mixture without precipitation upon mixing. When a solution is said to be instable it means a precipitate has formed upon mixing.

To achieve the stable formulation of the present invention, the order of addition of the constituents of the formulation is of great importance. According to the present method, a solution comprising a soluble metal salt, a nitrogen containing base and water is provided. Suitable soluble salts of a metal are salts of copper, silver, gold, tin, zinc and combinations thereof. As used herein by soluble is meant that the metal salt completely dissolves in the solution of water and nitrogen containing base. Alternatively the soluble metal salt may be a salt of copper, silver, zinc and combinations thereof. Further alternatively the soluble metal salt is a salt of silver.

As used herein “nitrogen containing base” is defined as a primary amine or ammonium hydroxide. The primary amine may be any primary amine known to those of ordinary skill in the art. Examples of suitable primary amines include methylamine, monoethanolamine and mixtures thereof. In the present invention mixtures of ammonium hydroxide and primary amines may also be used. The combination of the metal salt and primary amine may be accomplished by conventional methods known to those of ordinary skill in the art.

This solution is then mixed with a polymer which contains metal ion ligands. Suitable polymers containing metal ion ligands are described in U.S. Pat. No. 7,390,774 and U.S. Pat. No. 7,927,379. The combination of the solution and polymer may be accomplished by conventional methods known to those of ordinary skill in the art. Suitable metal ion ligands include vinyl imidazole and vinyl pyridine.

According to the present invention, additional water may be added. The water may be added at any point in the method. For example, additional water may be added to polymer. Alternatively, the water is added after the polymer is mixed with the solution. The amount of water added is determined by the desired metal ion concentration in the final formulation and by the desired ratio of metal ion to polymer.

Additionally, the method of the present invention may optionally include adding one or more antimicrobial agents, provided that the physical and chemical stability of the resultant antimicrobial composition is substantially unaffected by such inclusion. Antimicrobial agents suitable for use with the present invention include, for example, 3-iodo-2-propynylbutylcarbamate; 3-isothiazolones including 2-n-octyl-3-isothiazolone; zinc pyrithione; quaternary ammonium biocides such as dialkyldimethyl ammonium salts; trazole fungicides such as tebuconazole; 2-thiocyanomethylthio benzothiazole; thiobendazole; diiodomethyltolylsulfone; and phenolics such as 2,4,4′-trichloro-2′-hydroxy diphenyl ether.

Some embodiments of the present invention will now be described in detail in the following Examples. All fractions and percentages set forth below in the Examples are by weight unless otherwise specified.

### DESCRIPTION OF POLYMERS

Table I describes the monomer composition of each polymer product

TABLE I

| | Polymer | Polymer | Polymer | Polymer | Polymer |
|---|---|---|---|---|---|
| Monomer Composition | 1 | 2 | 3 | 4 | 5 |
| 1-vinylimidazole (VI) | 45% | 20% | 75% | 75% | |
| 4-vinylpyridine (VP) | | | | | 30% |
| Poly(ethylene glycol) | | | | 25% | 70% |
| methyl ether | | | | | |
| methacrylate (Mn 300) | | | | | |
| glacial acrylic acid | 15% | 40% | 10% | | |
| butyl acrylate | 40% | 40% | 15% | | |
| % Polymer Solids | 32% | 31.2% | 31.8% | 32% | 31.1% |

The polymers of the present invention were prepared according to the methods described in U.S. Pat. No. 7,390,774 and U.S. Pat. No. 7,927,379.

### Examples 1-9: Method to Formulate Antimicrobial Composition

Metal containing antimicrobial formulations were prepared using the following three order of addition methods with respective quantities listed in Table II:

Method A) Polymer 1, aqueous metal nitrate solution, ammonium hydroxide, DI water;
Method B) Polymer 1, ammonium hydroxide, aqueous metal nitrate solution, DI water;
Method C) Aqueous metal nitrate solution, ammonium hydroxide, polymer 1, DI water.

The formulation method was assessed by observation of precipitation upon mixing after the last component was added. Formulation stability is shown in Table III. Stability is indicated as an o and instability or precipitation is indicated as an x. Method C yields stable formulations which are compositions with VI:metal molar ratios of 11.6:1.

TABLE II

| | Form | Form | Form | Form | Form | Form | Form | Form | Form |
|---|---|---|---|---|---|---|---|---|---|
| Component | 1 | 2 | 3 | 4 | 5 | 6 | 7 | 8 | 9 |
| Silver Nitrate | 0.31 | 0.31 | 0.31 | 0.00 | 0.00 | 0.00 | 0.00 | 0.00 | 0.00 |
| (50%) (g) | | | | | | | | | |
| Copper Nitrate | 0.00 | 0.00 | 0.00 | 0.00 | 0.00 | 0.00 | 0.45 | 0.45 | 0.45 |
| (50%) (g) | | | | | | | | | |
| Zinc Nitrate | 0.00 | 0.00 | 0.00 | 0.55 | 0.55 | 0.55 | 0.00 | 0.00 | 0.00 |
| (50%) (g) | | | | | | | | | |
| Ammonium | 0.45 | 0.68 | 0.90 | 0.45 | 0.68 | 0.90 | 0.45 | 0.68 | 0.90 |
| Hydroxide | | | | | | | | | |
| (28% ammonia) | | | | | | | | | |
| (g) | | | | | | | | | |
| Polymer (g) | 7.04 | 7.04 | 7.04 | 7.04 | 7.04 | 7.04 | 7.04 | 7.04 | 7.04 |
| DI water (g) | 2.20 | 1.97 | 1.75 | 1.96 | 1.74 | 1.51 | 2.07 | 1.84 | 1.62 |

*Form = formulation

TABLE III

| | Example | Example | Example | Example | Example | Example | Example | Example | Example |
|---|---|---|---|---|---|---|---|---|---|
| | 1 | 2 | 3 | 4 | 5 | 6 | 7 | 8 | 9 |
| Metal | Silver | Silver | Silver | Zinc | Zinc | Zinc | Copper | Copper | Copper |
| Ammonia:metal | 8:1 | 12:1 | 16:1 | 8:1 | 12:1 | 16:1 | 8:1 | 12:1 | 16:1 |
| ratio | | | | | | | | | |
| Method A | x | x | x | x | x | x | x | x | X |
| Method B | x | x | x | x | x | x | x | x | X |
| Method C | ∘ | ∘ | ∘ | ∘ | ∘ | ∘ | ∘ | ∘ | ∘ |

### Examples 10-18: Method to Formulate Antimicrobial Composition

Metal containing antimicrobial formulations were prepared using the following three order of addition methods with respective quantities listed in Table IV:

Method A) Polymer 1, aqueous metal nitrate solution, ammonium hydroxide, DI water;
Method B) Polymer 1, ammonium hydroxide, aqueous metal nitrate solution, DI water;
Method C) Aqueous metal nitrate solution, ammonium hydroxide, polymer 1, DI water.

The formulation method was assessed by observation of precipitation upon mixing after the last component was added. Formulation stability is shown in Table V. Stability is indicated as an o and instability or precipitation is indicated as an x. Method C yields stable formulations which are compositions with VI:metal molar ratios of 8:1.

TABLE IV

| | Form | Form | Form | Form | Form | Form | Form | Form | Form |
|---|---|---|---|---|---|---|---|---|---|
| Component | 10 | 11 | 12 | 13 | 14 | 15 | 16 | 17 | 18 |
| Silver Nitrate | 0.31 | 0.31 | 0.31 | 0.00 | 0.00 | 0.00 | 0.00 | 0.00 | 0.00 |
| (50%) (g) | | | | | | | | | |
| Copper Nitrate | 0.00 | 0.00 | 0.00 | 0.00 | 0.00 | 0.00 | 0.45 | 0.45 | 0.45 |
| (50%) (g) | | | | | | | | | |
| Zinc Nitrate | 0.00 | 0.00 | 0.00 | 0.55 | 0.55 | 0.55 | 0.00 | 0.00 | 0.00 |
| (50%) (g) | | | | | | | | | |
| Ammonium | 0.45 | 0.68 | 0.90 | 0.45 | 0.68 | 0.90 | 0.45 | 0.68 | 0.90 |
| Hydroxide (g) | | | | | | | | | |
| Polymer (g) | 4.85 | 4.85 | 4.85 | 4.85 | 4.85 | 4.85 | 4.85 | 4.85 | 4.85 |
| DI water (g) | 4.39 | 4.16 | 3.94 | 4.15 | 3.93 | 3.70 | 4.25 | 4.03 | 3.80 |

TABLE V

| | Example | Example | Example | Example | Example | Example | Example | Example | Example |
|---|---|---|---|---|---|---|---|---|---|
| | 10 | 11 | 12 | 13 | 14 | 15 | 16 | 17 | 18 |
| Metal | Silver | Silver | Silver | Zinc | Zinc | Zinc | Copper | Copper | Copper |
| Ammonia:metal | 8:1 | 12:1 | 16:1 | 8:1 | 12:1 | 16:1 | 8:1 | 12:1 | 16:1 |
| ratio | | | | | | | | | |
| Method A | x | x | x | x | x | x | x | x | X |
| Method B | x | x | x | x | x | x | x | x | X |
| Method C | ∘ | ∘ | ∘ | x | ∘ | ∘ | x | ∘ | ∘ |

### Examples 19-24: Method to Formulate Antimicrobial Composition with Various Polymers

Zinc containing antimicrobial formulations were prepared using the following three order of addition methods with respective quantities listed in Table VI:

Method A) Indicated polymer from Table 1, aqueous zinc nitrate solution, ammonium hydroxide, DI water;
Method B) Indicated polymer from Table 1, ammonium hydroxide, aqueous zinc nitrate solution, DI water;
Method C) Aqueous zinc nitrate solution, ammonium hydroxide, indicated polymer from Table 1, DI water.

The formulation method was assessed by observation of precipitation upon mixing after the last component was added. Formulation stability is shown in Table VII. Stability is indicated as an o and instability or precipitation is indicated as an x. Method C yields stable formulations.

TABLE VI

| | Formulation | Formulation | Formulation | Formulation | Formulation | Formulation |
|---|---|---|---|---|---|---|
| Component | 19 | 20 | 21 | 22 | 23 | 24 |
| Zinc Nitrate | 0.55 | 0.55 | 0.55 | 0.55 | 0.55 | 0.55 |
| (50%) (g) | | | | | | |
| Ammonium | 0.68 | 0.68 | 0.68 | 0.68 | 1.35 | 1.35 |
| Hydroxide (g) | | | | | | |
| Polymer | Polymer 2 | Polymer 3 | Polymer 4 | Polymer 5 | Polymer 3 | Polymer 4 |
| product | | | | | | |
| Polymer (g) | 7.23 | 2.93 | 2.91 | 8.36 | 2.93 | 2.91 |
| DI water (g) | 1.55 | 5.85 | 5.86 | 0.42 | 5.17 | 5.19 |

TABLE VII

| | Example | Example | Example | Example | Example | Example |
|---|---|---|---|---|---|---|
| | 19 | 20 | 21 | 22 | 23 | 24 |
| Ammonia:metal | 12:1 | 12:1 | 12:1 | 12:1 | 24:1 | 24:1 |
| ratio | | | | | | |
| Method A | x | x | x | x | x | x |
| Method B | x | x | x | x | x | x |
| Method C | ∘ | x | x | ∘ | ∘ | ∘ |

### Examples 25-28: Method to Formulate Antimicrobial Composition without Ammonia

Zinc containing antimicrobial formulations were prepared using the following three order of addition methods with respective quantities listed in Table VIII:

Method A) Polymer 1, aqueous zinc nitrate solution, primary amine in Table VIII, DI water;
Method B) Polymer 1, primary amine in Table VIII, aqueous zinc nitrate solution, DI water;
Method C) Aqueous zinc nitrate solution, primary amine in Table VIII, polymer 1, DI water.

The amine:metal molar ratio was maintained at 16:1. The formulation method was assessed by observation of precipitation upon mixing after the last component was added. Formulation stability is shown in Table IX. Stability is indicated as an o and instability or precipitation is indicated as an x. Method C yields stable formulations for primary amines

TABLE VIII

| | Formulation | Formulation | Formulation | Formulation |
|---|---|---|---|---|
| Component | 25 | 26 | 27 | 28 |
| Zinc Nitrate | 0.55 | 0.55 | 0.55 | 0.55 |
| (50%) (g) | | | | |
| Amine (g) | 1.67 | 1.50 | 0.91 | 1.15 |
| Amine | Dimethyl- | Triethyl- | Monoetha- | Methylamine |
| | amine | amine | nolamine | |
| Polymer (g) | 4.85 | 4.85 | 4.85 | 4.85 |
| DI water (g) | 2.93 | 3.10 | 3.70 | 3.45 |

TABLE IX

| | Example 25 | Example 26 | Example 27 | Example 28 |
|---|---|---|---|---|
| Method A | x | x | x | x |
| Method B | x | x | x | x |
| Method C | x | x | o | o |

### Examples 29-32: Method to Formulate Antimicrobial Composition at Low Metal Levels

Silver containing antimicrobial formulations were prepared using the following three order of addition methods with respective quantities listed in Table X:

Method A) Polymer 1, aqueous silver nitrate solution, ammonium hydroxide, DI water;
Method B) Polymer 1, ammonium hydroxide, aqueous silver nitrate solution, DI water;
Method C) Aqueous silver nitrate solution, ammonium hydroxide, polymer 1, DI water.

The formulation method was assessed by observation of precipitation upon mixing after the last component was added. Formulation stability is shown in Table XI. Stability is indicated as an o and instability or precipitation is indicated as an x. Method C yields stable 0.05% and 0.1% silver formulations.

TABLE X

| | Formu- | Formu- | Formu- | Formu- |
|---|---|---|---|---|
| | lation | lation | lation | lation |
| Component | 29 | 30 | 31 | 32 |
| Silver Nitrate (10%) (g) | 0.16 | 0.08 | 0.16 | 0.08 |
| Ammonium Hydroxide (g) | 0.07 | 0.03 | 0.14 | 0.07 |
| Polymer (g) | 0.48 | 0.24 | 0.48 | 0.24 |
| DI water (g) | 9.29 | 9.65 | 9.22 | 9.61 |

TABLE XI

| | Example | Example | Example | Example |
|---|---|---|---|---|
| | 29 | 30 | 31 | 32 |
| Ammonia:metal ratio | 12:1 | 12:1 | 24:1 | 24:1 |
| Method A | x | x | x | x |
| Method B | x | x | x | x |
| Method C | x | x | o | o |

### Comparative Example 33: Method to Formulate Antimicrobial Composition at High Metal Levels

Silver containing antimicrobial formulations were prepared using the following three order of addition methods with respective quantities listed in Table XII:

Method A) Polymer 1, aqueous silver nitrate solution, ammonium hydroxide, DI water;
Method B) Polymer 1, ammonium hydroxide, aqueous silver nitrate solution, DI water;
Method C) Aqueous silver nitrate solution, ammonium hydroxide, polymer 1, DI water.

The formulation method was assessed by observation of precipitation upon mixing after the last component was added. Formulation stability is shown in Table XIII. Stability is indicated as an o and instability or precipitation is indicated as an x.

Method C yields a stable 3% silver formulation.

TABLE XII

| Component | Formulation 33 |
|---|---|
| Silver Nitrate (50%) (g) | 0.94 |
| Ammonium Hydroxide (g) | 1.35 |
| Polymer (g) | 7.27 |
| DI water (g) | 0.43 |

TABLE XIII

| | Example 33 |
|---|---|
| Method A | x |
| Method B | x |
| Method C | o |

### Comparative Example 34: Method to Formulate Antimicrobial Composition

Silver containing antimicrobial formulations were prepared using the following three order of addition methods with respective quantities listed in Table XIV:

Method A) Polymer 1, aqueous silver nitrate solution, ammonium hydroxide, DI water;
Method B) Polymer 1, ammonium hydroxide, aqueous silver nitrate solution, DI water;
Method C) Aqueous silver nitrate solution, ammonium hydroxide, polymer 1, DI water.

The formulation method was assessed by observation of precipitation upon mixing after the last component was added. Formulation stability is shown in Table XV. Stability is indicated as an o and instability or precipitation is indicated as an x. Method C yields a stable silver based formulation with a VI:silver molar ratio of 4.9:1 and an ammonia:metal molar ratio of 6.8:1.

TABLE XIV

| Recipe | Formulation 34 |
|---|---|
| Silver Nitrate (50%) (g) | 0.31 |
| Ammonium Hydroxide (g) | 0.38 |
| Polymer (g) | 2.97 |
| DI water (g) | 6.33 |

TABLE XV

| | Example 34 |
|---|---|
| Method A | x |
| Method B | x |
| Method C | o |

### Comparative Example 35: Method to Formulate Antimicrobial Composition

Silver containing antimicrobial formulations were prepared using the following three order of addition methods with respective quantities listed in Table XVI with and without stirring:

Method A) Polymer 1 diluted to 21% solids, aqueous silver nitrate solution, ammonium hydroxide, DI water;
Method B) Polymer 1 diluted to 21% solids, ammonium hydroxide, aqueous silver nitrate solution, DI water;
Method C) Aqueous silver nitrate solution, ammonium hydroxide, polymer 1 diluted to 21% solids, DI water.

The formulation method was assessed by observation of precipitation upon mixing after the last component was added. Formulation stability is shown in Table XVII. Stability is indicated as an o and instability or precipitation is indicated as an x. Method C yields a stable formulation.

TABLE XVI

| Recipe | Formulation 35 |
|---|---|
| Silver Nitrate (50%) (g) | 0.90 |
| Ammonium Hydroxide (g) | 2.0 |
| Polymer (g) | 10.0 |

TABLE XVII

| | Example 35 No Stirring | Example 35Stirring |
|---|---|---|
| Method A | x | x |
| Method B | x | x |
| Method C | o | o |

We claim:

1. A method for preparing a stable formulation comprising:
ii) providing a solution of:
a) a salt of a metal;
b) a nitrogen containing base; and
c) water
ii) mixing the solution with a polymer wherein the polymer contains metal ion ligands.

2. The method of claim 1 wherein the metal is selected from copper, silver, gold, tin, zinc and combinations thereof.

3. The method of claim 2 wherein the metal is silver.

4. The method of claim 1 wherein the nitrogen containing base is ammonium hydroxide.

5. The method of claim 1 wherein the nitrogen containing base is a primary amine.

6. The method of claim 1 wherein water is added to the polymer.

7. The method of claim 1 wherein water is added after the polymer is mixed with the solution.
